(19) United States
(12) Patent Application Publication
(10) Pub. No.: US 2026/0261329 A1
(43) Pub. Date: Sep. 3, 2026

(54) METHOD FOR DYNAMIC BEAM ALIGNMENT IN STATELLITE COMMUNICATIONS

(71) Applicant: YTTEK Technology Corp., Zhubei City (TW)

(72) Inventor: CHUNG-LIEN HO, Zhubei City (TW)

(21) Appl. No.: 19/390,771

(22) Filed: Nov. 17, 2025

Related U.S. Application Data
(60) Provisional application No. 63/765,350, filed on Feb. 28, 2025.

(51) Int. Cl. H04B 7/185

(52) U.S. Cl. CPC H04B 7/18513

(57) ABSTRACT

The present invention discloses a method for dynamic beam alignment in satellite communications (SATCOM). The method determines a dynamic beam direction between an antenna of a user terminal (UT) located on the Earth's surface and a satellite in orbit by calculating azimuth and elevation angles required for beam alignment. The beam direction is determined based on at least one of an electromechanical operation, a tracking scope, and a step-tracking technique.

This application claims the priority benefit of provisional patent application No. 63/765,350 titled “METHOD FOR DYNAMIC BEAM ALIGNMENT IN SATELLITE COMMUNICATIONS” filed on 28 Feb. 2025, the disclosure of which is incorporated by reference herein in its entirety.

### BACKGROUND OF THE INVENTION

### Field of Invention

The present invention relates to the field of satellite communications (SATCOM), and more particularly to a method for dynamic beam alignment in SATCOM.

### Description of the Related Art

Satellite communications primarily involve the transmission of signals through electromagnetic beams between ground-based user terminals (UTs) and target satellites in Earth orbit. The UTs include both fixed and mobile communications equipment. The mobile communications equipment includes, but is not limited to, devices installed on movable platforms such as ships and vehicles on the Earth's surface. Beam alignment between an antenna of the UT and the target satellite is essential to ensure accurate link transmission.

The antenna of the UT uses the directivity of the beam to focus the signals toward the target satellite, thereby ensuring accurate link transmission. When relative movement occurs between the antenna of the UT and the target satellite, the antenna must continuously track the target satellite by dynamically adjusting the beam direction to maintain alignment.

The dynamic beam alignment described in the present invention refers to a process in which the antenna of the UT tracks the target satellite and calculates azimuth and elevation angles required to adjust the pointing direction of the antenna so that the beam of the antenna is aligned with the target satellite.

### SUMMARY OF THE INVENTION

The main purpose of the present invention is to provide a method for dynamic beam alignment in satellite communications (SATCOM).

In order to achieve the aforementioned purpose, the present invention employs the following technical solution:

A method for dynamic beam alignment in satellite communications, wherein, when an antenna of a user terminal (UT) located on the Earth's surface moves relative to a target satellite in orbit, the antenna of the UT tracks the target satellite by obtaining azimuth and elevation angles required to adjust the pointing direction of the antenna, thereby aligning a beam of the antenna with the target satellite.

During an initial search, when the antenna of the UT establishes a link connection with the target satellite, the azimuth and elevation angles are obtained by a method including an electromechanical operation.

The electromechanical operation comprises the following tracking mechanisms:

Pure mechanical tracking: tracking through a mechanical triple-axis shaft having a fixed phase;

Pure electrical tracking: tracking through an electrical phasor employing dynamically adjustable antenna phase shifters; and

Hybrid tracking: tracking through a combination of the mechanical triple-axis shaft and the electrical phasor to achieve a balance between the pure mechanical tracking and the pure electrical tracking.

The dynamic beam alignment method for satellite communications of the present invention integrates the electromechanical operation, the tracking scope, and the step-tracking technique into the determination process of the azimuth angle and the elevation angle, and establishes a priority order for dynamic adjustment. Compared with the prior art, the method provides higher tracking accuracy, faster alignment speed, and lower scanning loss. Furthermore, the method can reduce system maintenance costs and extend service life of the system, thereby offering significant advancement.

### BRIEF DESCRIPTION OF THE DRAWINGS

FIG. 1 illustrates a schematic diagram of the UT's antenna beam alignment;

FIG. 2 illustrates the relationship among operations for obtaining parameters used to determine the azimuth and elevation angles;

FIG. 3 illustrates a full-size beam direction table used to obtain the azimuth and elevation angles;

FIG. 4 illustrates the full-size beam direction table shown in FIG. 3;

FIG. 5 illustrates a continuation of the beam direction table shown in FIG. 4;

FIG. 6 illustrates a continuation of the beam direction table shown in FIG. 5; and

FIG. 7 illustrates a continuation of the beam direction table shown in FIG. 6.

### DETAILED DESCRIPTION OF THE PREFERRED EMBODIMENTS

The accompanying drawings illustrate preferred embodiments of a method for dynamic beam alignment in satellite communications. However, these embodiments are provided for illustrative purposes only and are not intended to limit the scope of the present invention.

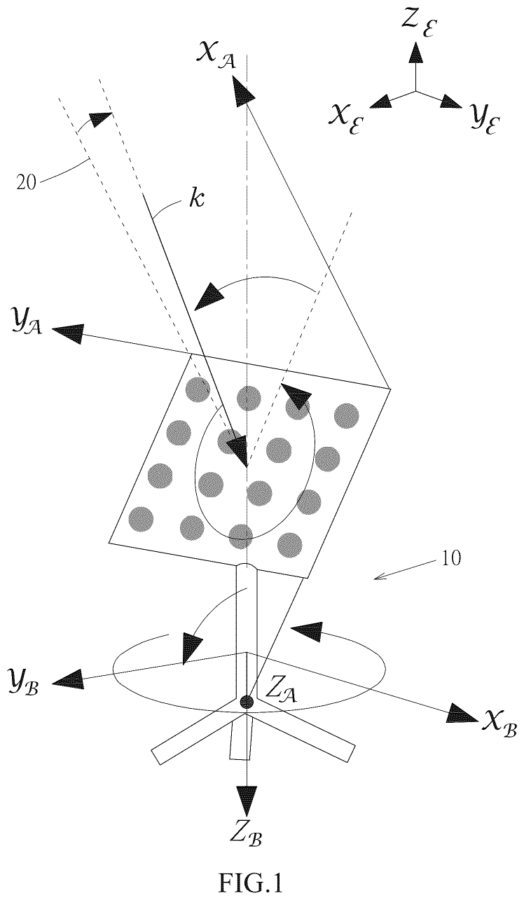

As shown in FIG. 1, in the method for dynamic beam alignment in satellite communications, an antenna 10 of a user terminal (UT) located on the Earth's surface moves relative to a target satellite (not shown). The antenna 10 tracks the target satellite and obtains an azimuth angle φ and an elevation angle θ required to rotate an antenna broadside direction 20 so as to align a beam direction k with the target satellite. The antenna broadside direction 20 is defined as (\hat{θ}ₘ,\hat{φ}ₘ)=(π/2.0), and the beam direction k is defined as (\hat{θ}ₒ,\hat{φ}ₒ)=(θ′_{ZOA},φ′_{AOA}).

The azimuth angle φ and elevation angle θ may be determined based on at least one parameter obtained from an electromechanical operation, a tracking scope, or a step-tracking technique, in the following order of priority:
electromechanical operation>tracking scope>step-tracking.

The configuration of the tracking scope and the step-tracking technique in a given direction depends on the configuration of the electromechanical operation in that direction, and the configuration of the step-tracking technique in that direction is further influenced by both the electromechanical operation and the tracking scope.

During an initial search, when the antenna 10 of the UT establishes a link connection with the target satellite, the azimuth and elevation angles are obtained using a method that includes the electromechanical operation.

The electromechanical operation comprises the following tracking mechanisms:

Pure mechanical tracking: tracking by a mechanical triple-axis shaft with a fixed phase, such as the broadside direction of a horn antenna, to obtain (\hat{θ}ₒ,\hat{φ}ₒ)=(\hat{θ}ₘ,\hat{φ}ₘ)=(π/2.0). This method is characterized by low accuracy, no scanning loss at large angles, slow tracking speed, the presence of wear-and-tear, and low cost.

Pure electrical tracking: tracking by an electrical phasor with dynamically adjustable antenna phase shifters to obtain (\hat{θ}ₒ,\hat{φ}ₒ)=(\hat{θ}ₑ,\hat{φ}ₑ). This method is characterized by high accuracy, scanning loss at large angles, fast tracking speed, no wear-and-tear, and high cost.

Hybrid tracking: tracking jointly by the mechanical triple-axis shaft and the electrical phasor to achieve a balance between the pure mechanical tracking and the pure electrical tracking.

The hybrid tracking is performed by a mechanical adjustment and an electrical adjustment. First, a one-step mechanical adjustment is performed for a large-scale tracking scope, followed by a one-step or multi-step electrical adjustment within a small-scale tracking scope.

The one-step electrical adjustment is a programmed tracking based on the geographical locations of the target satellite and the antenna 10.

The multi-step electrical adjustment may be implemented by a step tracking method based on previous tracking results and a receive signal strength indicator (RSSI). The step tracking may employ at least one of the following methods: a direct search method, a gradient method, and a quadratic approximation method.

The mechanical adjustment is performed through a fixed-phase equivalent beam direction (\hat{θ}ₘ,\hat{φ}ₘ)=(π/2.0) by rotating and adjusting a bearing axis, a down-tilt axis, and a slant axis of a mechanical triple-axis shaft of an antenna 10 of a user terminal (UT) to control a triple-axis direction (\hat{α}ᵣₓ,\hat{β}ᵣₓ,\hat{γ}ᵣₓ) of the antenna 10. A pointing error (θₑ,φₑ)≡(\hat{θ}ₘ−θ′_{ZOA},\hat{φ}ₘ−φ′_{AOA}) of the triple-axis direction (\hat{α}ᵣₓ,\hat{β}ᵣₓ,\hat{γ}ᵣₓ) of the antenna 10 relative to an incoming direction (θ′_{ZOA},φ′_{AOA}) of a target satellite is a function of the triple-axis direction (\hat{α}ᵣₓ,\hat{β}ᵣₓ,\hat{γ}ᵣₓ), namely, (θ′_{ZOA},φ′_{AOA})=ƒ(\hat{α}ᵣₓ,\hat{β}ᵣₓ,\hat{γ}ᵣₓ). By adjusting the triple-axis direction (\hat{α}ᵣₓ,\hat{β}ᵣₓ,\hat{γ}ᵣₓ) through the bearing, down-tilt, and the slant axes, an equivalent beam direction (\hat{θ}ₘ,\hat{φ}ₘ)≡(π/2.0) having a fixed phase is obtained. The equivalent beam direction with the fixed phase corresponds to an antenna broadside direction 20, enabling the antenna 10 to point toward the target satellite as closely as possible.

An electrical adjustment obtains an equivalent beam direction (\hat{θ}ₑ,\hat{φ}ₑ) having a dynamic phase through antenna phase shifters of the antenna 10. The equivalent beam direction (\hat{θ}ₑ,\hat{φ}ₑ) with the dynamic phase is a function of the triple-axis direction (\hat{α}ᵣₓ,\hat{β}ᵣₓ,\hat{γ}ᵣₓ) (bearing, down-tilt, and slant), namely, (\hat{θ}ₑ,\hat{φ}ₑ)=ƒ(\hat{α}ᵣₓ,\hat{β}ᵣₓ,\hat{γ}ᵣₓ). An overall beam direction (\hat{θ}ₒ,\hat{φ}ₒ) is obtained by combining the mechanical and electrical adjustments. After the mechanical adjustment, the electrical adjustment of the antenna phase shifters generates the equivalent beam direction (\hat{θ}ₑ,\hat{φ}ₑ)=ƒ(\hat{α}ᵣₓ,\hat{β}ᵣₓ,\hat{γ}ᵣₓ) with the dynamic phase, such that the overall beam direction (\hat{θ}ₒ,\hat{φ}ₒ) can point toward the incoming direction (θ′_{ZOA},φ′_{AOA}) of the target satellite.

Accordingly,

$$( {\hat{θ}}_{e} , {\hat{ϕ}}_{e} ) = f ( {\hat{α}}_{r x} , {\hat{β}}_{r x} , {\hat{γ}}_{rx} ) = ( {θ}_{e} , {ϕ}_{e} ) = ( {\hat{θ}}_{m} - {θ}_{ZOA}^{′} , {\hat{ϕ}}_{m} - {ϕ}_{A O A}^{′} ) = ( π / 2 - {θ}_{Z O A}^{′} , - {ϕ}_{A O A}^{′} ) = ( π / 2 - {\hat{θ}}_{o} , - {\hat{ϕ}}_{o} ) .$$

Eventually,

$$( {\hat{θ}}_{o} , {\hat{ϕ}}_{o} ) = ( {θ}_{ZOA}^{′} , {ϕ}_{A O A}^{′} ) = ( π / 2 - {\hat{θ}}_{e} , 0 - {\hat{ϕ}}_{e} ) = ( {\hat{θ}}_{m} - {\hat{θ}}_{e} , {\hat{ϕ}}_{m} - {\hat{ϕ}}_{e} ) = f ( {\hat{α}}_{rx} , {\hat{β}}_{rx} , {\hat{γ}}_{rx} ) .$$

As summarized in FIG. 1, the hybrid tracking process can be described as follows. In the mechanical adjustment, an incoming path direction (θ′_{ZOA},φ′_{AOA})=ƒ(\hat{α}ᵣₓ,\hat{β}ᵣₓ,\hat{γ}ᵣₓ) of the target satellite is obtained with respected to the antenna broadside of the antenna 10. The mechanical adjustment is performed by adjusting the antenna triple-axis direction (\hat{α}ᵣₓ,\hat{β}ᵣₓ,\hat{γ}ᵣₓ) of the antenna 10, where the corresponding fixed beam direction is (\hat{θ}ₘ,\hat{φ}ₘ)≡(π/2.0), and the pointing error is (θₑ,φₑ)≡(\hat{θ}ₘ−θ′_{ZOA},\hat{φ}ₘ−φ′_{AOA}). In the electrical adjustment, the antenna phase shifters of the antenna 10 are dynamically adjusted to achieve the dynamic phase (\hat{θ}ₑ,\hat{φ}ₑ). The overall beam direction is (\hat{θ}ₒ,\hat{φ}ₒ), and the corresponding solution is (\hat{θ}ₒ,\hat{φ}ₒ)=(θ′_{ZOA},φ′_{AOA}), and the corresponding solution is (\hat{θ}ₑ,\hat{φ}ₑ)=(θₑ,φₑ)=ƒ(\hat{α}ᵣₓ,\hat{β}ᵣₓ,\hat{γ}ᵣₓ).

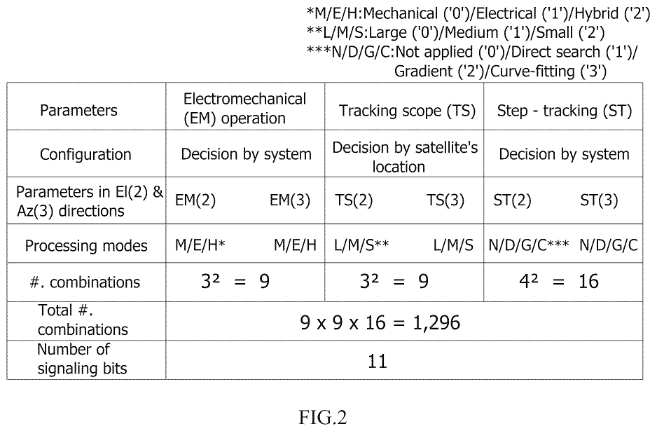

As illustrated in FIG. 2, in satellite communications, the azimuth angle φ and the elevation angle θ of the dynamic beam direction from the antenna 10 of the UT to the target satellite are determined based on the at least one parameter obtained from the electromechanical operation, the tracking scope, or the step-tracking technique in the corresponding direction.

For the tracking scope, a large scope (‘0’) is defined as satisfying at least one of the following conditions: Θ_{HF}≤|θₑ| and Φ_{HF}≤|φₑ|, wherein Θ_{HF} and Φ_{HF} respectively represent half of the field-of-view (FoV) angles along the elevation angle θ and the azimuth angle φ, and are determined according to a signal-to-noise ratio (SNR). For example: Θ_{HF}=15°,Φ_{HF}=10°.

A medium scope (‘1’) is defined as satisfying at least one of the following conditions: Θ_{H3dB}≤|θₑ|<Θ_{HF} and Φ_{H3dB}≤|θₑ|<Φ_{HF}, wherein Θ_{H3dB} and Φ_{H3dB} respectively represent half of the 3 dB beamwidths along the elevation angle θ and the azimuth angle φ, and are determined according to the corresponding beamwidths. For example: Θ_{H3dB}=Θ_{3dB}/2,Φ_{3dB}=Φ_{H3dB}/2, where Θ_{3dB}=Φ_{3dB}=3.16° applies to a 32-element antenna array. It is noted that Θ_{H3dB}<Θ_{HF}.

A small scope (‘2’) is defined as satisfying at least one of the following conditions: |θₑ|<Θ_{3dB} and |φₑ|<Φ_{3dB}.

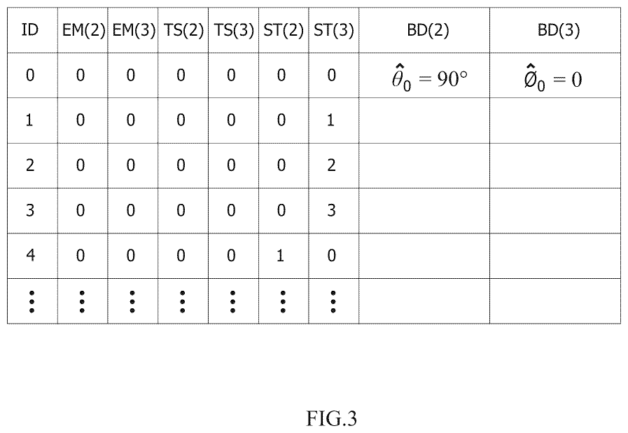

FIG. 3 illustrates a full-size beam direction table used to obtain the elevation angle θ and azimuth angle φ. Here, “full-size” refers to a large-scale data structure requiring more than eleven (11) signaling bits to completely represent all possible beam directions in the beam direction table.

Certain inapplicable situations may occur in the full-size beam direction table shown in FIG. 3. Such situations arise when the electromechanical operation, the tracking scope, and the step-tracking technique have already been determined. In these cases, the tracking modes of the tracking scope and the step-tracking technique depend on the electromechanical operation. For example, if an electromechanical operation mode in a given direction is determined to be the mechanical adjustment, then the tracking scope and step-tracking modes in that direction are irrelevant.

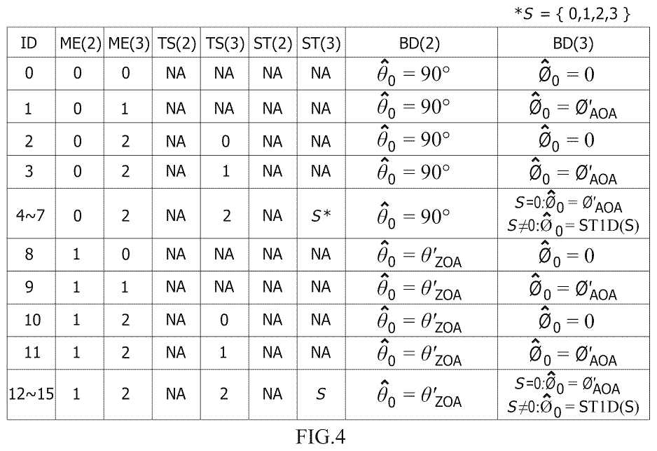

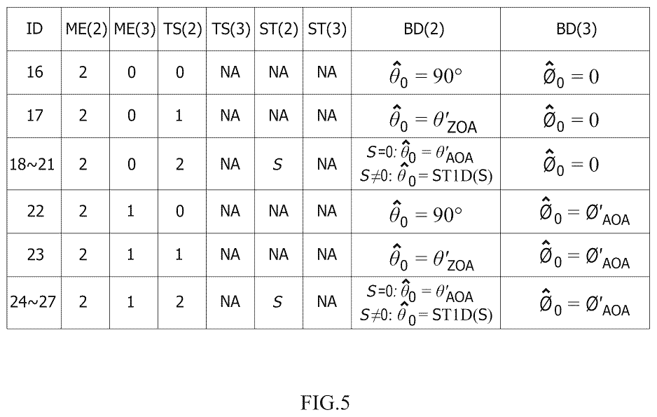

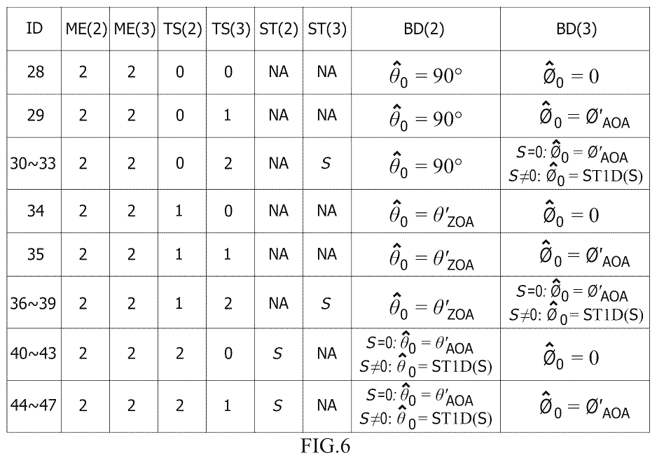

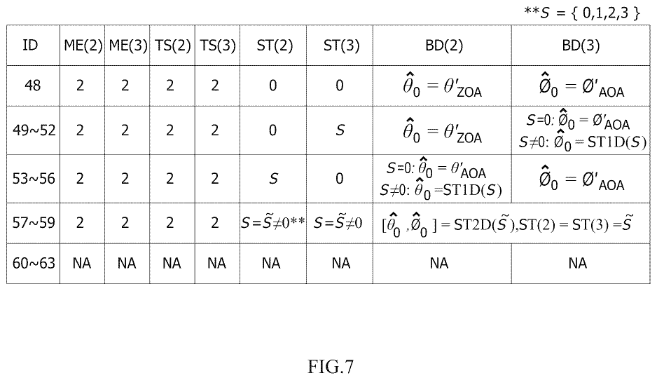

As shown in FIGS. 4 to 7, more refined beam direction tables are provided, each presenting multiple practical embodiments of the elevation angle θ and the azimuth angle φ. These refined beam direction tables are smaller than the aforementioned full-size table and require fewer signaling bits (for example, 6-bit signaling representation), thereby reducing signaling overhead.

The prior art typically relies on a single pure mechanical tracking or pure electrical tracking method, in which tracking efficiency and accuracy are limited under different operational scenarios. The present invention determines the azimuth angle and the elevation angle based on parameters obtained from multiple sources, wherein the calculation of the azimuth and elevation angles is based on at least one of the electromechanical operation, the tracking scope, and the step-tracking technique, and is performed according to a predetermined priority order. This provides a more flexible and adaptive computational architecture.

The hierarchical priority logic, wherein the electromechanical operation takes precedence over the tracking scope and the tracking scope takes precedence over the step-tracking technique, forms a decision-making mechanism with a defined priority order. This logic ensures that the system automatically selects the optimal tracking strategy under different error magnitudes and tracking stages, thereby improving the overall beam alignment speed and stability.

When the electromechanical operation is insufficient to achieve complete alignment, the tracking scope may be used to determine the error level, and the step-tracking technique may be employed to perform gradual corrections. This forms a layered decision-making and multi-step compensation mechanism that significantly reduces beam offset and ensures that the antenna broadside direction can remain stably pointed toward the target satellite over time, thereby enhancing tracking accuracy and reliability.

Compared with conventional technologies that rely solely on large-angle scanning, the present invention first utilizes the electromechanical operation for coarse alignment over large scopes to narrow the error range, and then performs fine compensation. This approach reduces scanning loss, improves efficiency, minimizes unnecessary scanning, reduces signal loss, and enhances computational performance.

The electromechanical operation performs the coarse adjustment, thereby reducing the operational load on the electrical adjustment. The step-tracking technique is activated only when necessary, reducing excessive operation of the antenna phase shifters and minimizing mechanical wear. As a result, the overall system lifespan is extended, maintenance costs are reduced, and both performance and cost-efficiency are improved.

What is claimed is:

1. A dynamic beam alignment method for satellite communications, wherein, when an antenna of a user terminal (UT) located on the Earth's surface moves relative to a target satellite in orbit, the method comprises obtaining an azimuth angle and an elevation angle required to adjust a pointing direction of the antenna so as to align a beam of the antenna with the target satellite;
wherein the azimuth angle and the elevation angle are determined based on at least one parameter, the parameter being selected from at least one of an electromechanical operation, a tracking scope, and a step-tracking technique, and wherein a priority order of sources of the parameter is that the electromechanical operation takes precedence over the tracking scope, and the tracking scope takes precedence over the step-tracking technique;
wherein the electromechanical operation includes the following tracking mechanisms executed in sequence:
(a) pure mechanical tracking, which performs tracking through a mechanical triple-axis shaft with a fixed phase;
(b) pure electrical tracking, which performs tracking through an electrical phasor having dynamically adjustable antenna phase shifters; and
(c) hybrid tracking, which performs tracking through both the mechanical triple-axis shaft and the electrical phasor jointly, thereby achieving a balance between the pure mechanical tracking and the pure electrical tracking.

2. The dynamic beam alignment method for satellite communications as claimed in claim 1, wherein the hybrid tracking comprises first performing a one-step mechanical adjustment for a large-scale tracking scope, followed by a one-step electrical adjustment or a multi-step electrical adjustment within a small-scale tracking scope.

3. The dynamic beam alignment method for satellite communications as claimed in claim 2, wherein the one-step electrical adjustment is a programmed tracking operation based on geographic locations of the target satellite and the antenna of the UT.

4. The dynamic beam alignment method for satellite communications as claimed in claim 2, wherein the multi-step electrical adjustment is implemented by step-tracking, and wherein adjustments are made based on previous tracking results according to a receive signal strength indicator (RSSI).

5. The dynamic beam alignment method for satellite communications as claimed in claim 4, wherein the step-tracking employs at least one of, or a combination of, a direct search method, a gradient method, and a quadratic approximation method.

6. The dynamic beam alignment method for satellite communications as claimed in claim 1, wherein the tracking scope includes:
(a) a large scope, defined as satisfying at least one of Θ_{HF}≤|θₑ| and Φ_{HF}≤|φₑ|, wherein Θ_{HF} and Φ_{HF} respectively represent half of field-of-view angles along the elevation angle θ and the azimuth angle φ, and are determined according to a signal-to-noise ratio (SNR); for example, Θ_{HF}=15°,Φ_{HF}=10°;
(b) a medium scope, defined as satisfying at least one of Θ_{H3dB}≤|θₑ|<Θ_{HF} and Φ_{H3dB}≤|θₑ|<Φ_{HF}, wherein Θ_{H3dB} and Φ_{H3dB} respectively represent half of a 3 dB beamwidth along the elevation angle θ and the azimuth angle φ, and are determined according to corresponding beamwidths; for example, Θ_{H3dB}=Θ_{3dB}/2,Φ_{3dB}=Φ_{H3dB}/2, where Θ_{3dB}=Φ_{3dB}=3.16°, applicable to a 32-element antenna array, and wherein Θ_{H3dB}<Θ_{HF}; and
(c) a small scope, defined as satisfying at least one of |θₑ|<Θ_{3dB} and |φₑ|<Φ_{3dB}.

7. The dynamic beam alignment method for satellite communications as claimed in claim 6, wherein, in the large scope, Θ_{HF}=15° and Φ_{HF}=10°.

8. The dynamic beam alignment method for satellite communications as claimed in claim 6, wherein, in the medium scope, Θ_{H3dB}=Θ_{3dB}/2,Φ_{3dB}=Φ_{H3dB}/2, and Θ_{H3dB}<Θ_{HF}.

9. The dynamic beam alignment method for satellite communications as claimed in claim 8, wherein Θ_{3dB}=Φ_{3dB}=3.16°, applicable to a 32-element antenna array.
